(19) United States
(12) Patent Application Publication
(10) Pub. No.: US 2010/0033960 A1
(43) Pub. Date: Feb. 11, 2010

(54) LIGHTING DEVICE

(76) Inventor: Jonathan E. Levine, New York, NY (US)

Correspondence Address: THEODORE W. BAKER, 612 Stinson St, Independence, OR, 97351, US

(21) Appl. No.: 12/186,875

(22) Filed: Aug. 6, 2008

(51) Int. Cl. F21S 6/00

(52) U.S. Cl. 362/198

(57) ABSTRACT

A lighting device is disclosed. The lighting device can include a base, an elongated light bar, and extendable arms connecting the elongated light bar to the base. A long axis of the elongated light bar can be substantially perpendicular to long axes of the extendable arms. The extendable arms can be rotatable relative to the base around a first rotation axis. The elongated light bar can be rotatable relative to the extendable arms around a second rotation axis. The first and second rotation axes can be substantially parallel to the long axis of the elongated light bar. The lighting device can be collapsible into a compact configuration with, for example, the elongated light bar positioned adjacent to a front surface of the base and the extendable arms positioned, respectively, adjacent to side surfaces of the base. The elongated light bar can include two or more light emitting diodes.

### FIELD

This disclosure concerns lighting devices, such as lighting devices with extendable arms that can be collapsed to convert the lighting devices into more compact configurations.

### BACKGROUND

Several varieties of lighting devices with extendable arms are known. For example, U.S. Pat. No. 5,012,394 (U.S. '394) discloses a “hand portable light” including a “lamp housing . . . mounted to [a] base . . . by two telescoping collapsible support arms.” U.S. '394, abstract. In the lighting device of U.S. '394, the “lamp housing is mounted to the telescoping support arms with pivots which allow the lamp housing to be pivoted with respect to the collapsible support arms.” U.S. '394, abstract. Similarly, U.S. Pat. No. 5,265,000 (U.S. '000) discloses a “telescopic and collapsible desk lamp” including “a lamp shade pivotally connected to a telescopic support.” U.S. '000, abstract. The “telescopic support” of the lighting device of U.S. '000 includes “two telescopic metal tubes pivotally connected to two metal mounting tubes.” U.S. '000, abstract.

### SUMMARY

Disclosed herein are embodiments of a lighting device. Some of these embodiments include a base, an elongated light bar, and first and second extendable arms connecting the elongated light bar to the base. The first and second extendable arms can be connected to first and second side surfaces of the base, respectively. A long axis of the elongated light bar can be substantially perpendicular to long axes of the first and second extendable arms. The first and second extendable arms can be rotatable relative to the base around a first rotation axis. In some disclosed embodiments, the range over which the first and second extendable arms are rotatable around the first rotation axis is restricted. The elongated light bar can be rotatable relative to the first and second extendable arms around a second rotation axis. The first and second rotation axes can be substantially parallel to the long axis of the elongated light bar.

Some disclosed embodiments are collapsible into a compact configuration. In the compact configuration, the elongated light bar can be positioned adjacent to a front surface of the base and the first and second extendable arms can be positioned adjacent to the first and second side surfaces of the base, respectively. The long axes of the first and second extendable arms also can be substantially parallel to a support or mounting surface and/or substantially perpendicular to the front surface of the base. Furthermore, the elongated light bar and the first and second extendable arms can be positioned so as not to project substantially beyond a top surface of the base. First and second extendable arm supports can be included to releaseably secure the first and second extendable arms, respectively, to the base when the lighting device is in the compact configuration. The first and second extendable arm supports also can restrict rotation of the first and second extendable arms, respectively, around the first rotation axis.

The elongated light bar can include two or more light emitting diodes positioned, for example, behind a substantially transparent window. The length of the substantially transparent window can be between about 50% and about 100% of the length of the elongated light bar. The first and second extendable arms can be telescoping. The base can include a battery compartment, a storage compartment, or both. The base also can include a mounting clip, such as a mounting clip that is spring-loaded to retract into a mounting clip recess within the base. In some disclosed embodiments, the base is shaped substantially as a rectangular solid. The base also can have a cross-sectional profile in a plane substantially perpendicular to the long axis of the elongated light bar having a height-to-width ratio, for example, from about 1:3 to about 1:20.

### BRIEF DESCRIPTION OF THE DRAWINGS

FIG. 1 is a perspective view of a first embodiment of the disclosed lighting device in an expanded configuration with the first and second extendable arms fully extended, as viewed from the top and one side thereof.

FIG. 2 is a front elevation view of the embodiment shown in FIG. 1 in the expanded configuration.

FIG. 3 is a first side elevation view of the embodiment shown in FIG. 1 in the expanded configuration.

FIG. 4 is a second side elevation view of the embodiment shown in FIG. 1 in the expanded configuration.

FIG. 5 is a back elevation view of the embodiment shown in FIG. 1 in the expanded configuration.

FIG. 6 is a top plan view of the embodiment shown in FIG. 1 in the expanded configuration.

FIG. 7 is a bottom plan view of the embodiment shown in FIG. 1 in the expanded configuration.

FIG. 8 is a perspective view of the embodiment shown in FIG. 1 in a compact configuration with the first and second extendable arms fully retracted and positioned adjacent to the side surfaces of the base, as viewed from the top and one side thereof.

FIG. 9 is a perspective view of the embodiment shown in FIG. 1 in a partially expanded configuration with the first and second extendable arms fully retracted and rotated away from the side surfaces of the base and the mounting clips extended away from the base, as viewed from the bottom and one side thereof.

FIG. 10 is a perspective view of a second embodiment of the disclosed lighting device in an expanded configuration with the first and second extendable arms fully extended, as viewed from the top and one side thereof.

FIG. 11 is a front elevation view of the embodiment shown in FIG. 10 in the expanded configuration.

FIG. 12 is a first side elevation view of the embodiment shown in FIG. 10 in the expanded configuration.

FIG. 13 is a second side elevation view of the embodiment shown in FIG. 10 in the expanded configuration.

FIG. 14 is a back elevation view of the embodiment shown in FIG. 10 in the expanded configuration.

FIG. 15 is a top plan view of the embodiment shown in FIG. 10 in the expanded configuration.

FIG. 16 is a bottom plan view of the embodiment shown in FIG. 10 in the expanded configuration.

FIG. 17 is a perspective view of the embodiment shown in FIG. 10 in a compact configuration with the first and second extendable arms fully retracted and positioned adjacent to the side surfaces of the base, as viewed from the top and one side thereof.

FIG. 18 is a perspective view of the embodiment shown in FIG. 10 in the compact configuration with the mounting clips extended away from the base, as viewed from the bottom and one side thereof.

FIG. 19 is a perspective view of a third embodiment of the disclosed lighting device in an expanded configuration with the first and second extendable arms fully extended, as viewed from the top and one side thereof.

FIG. 20 is a front elevation view of the embodiment shown in FIG. 19 in the expanded configuration.

FIG. 21 is a first side elevation view of the embodiment shown in FIG. 19 in the expanded configuration.

FIG. 22 is a second side elevation view of the embodiment shown in FIG. 19 in the expanded configuration.

FIG. 23 is a back elevation view of the embodiment shown in FIG. 19 in the expanded configuration.

FIG. 24 is a bottom plan view of the embodiment shown in FIG. 19 in the expanded configuration.

FIG. 25 is a top plan view of the embodiment shown in FIG. 19 in the expanded configuration.

FIG. 26 is a side elevation view of the embodiment shown in FIG. 19 in a compact configuration with the first and second extendable arms fully retracted and positioned adjacent to the side surfaces of the base.

### DETAILED DESCRIPTION

Throughout this disclosure, the singular terms “a,” “an,” and “the” include plural referents unless the context clearly indicates otherwise. Similarly, the word “or” is intended to include “and” unless the context clearly indicates otherwise. As used herein the word “connected” does not exclude the presence of one or more intervening elements. Directional terms, such as “upper,” “lower,” “front,” “back,” “vertical,” and “horizontal,” are used herein to express and clarify the relationship between various elements. It should be understood that such terms do not denote absolute orientation (e.g., a “vertical” component can become horizontal by rotating the device).

Described herein are embodiments of a lighting device with a wide variety of potential uses. For example, some disclosed embodiments can be positioned upright on a horizontal surface (e.g., a desk), clipped or mounted to a non-horizontal surface (e.g., a book, a laptop computer, or a wall), and/or mounted below a horizontal surface (e.g., the underside of a kitchen cabinet). Furthermore, some disclosed embodiments can be converted between an expanded configuration and a compact configuration. For example, these embodiments can include two extendible arms that support opposite ends of an elongated light bar. In the compact configuration, the extendible arms can be retracted and rotated so that they are adjacent to side surfaces of a base, with the elongated light bar positioned adjacent to a front surface of the base. In the expanded configuration, the extendible arms can be extended to increase the distance between the light bar and the base. The light bar also can be rotated relative to the extendable arms to allow, for example, convenient, adjustment of the direction of emitted light.

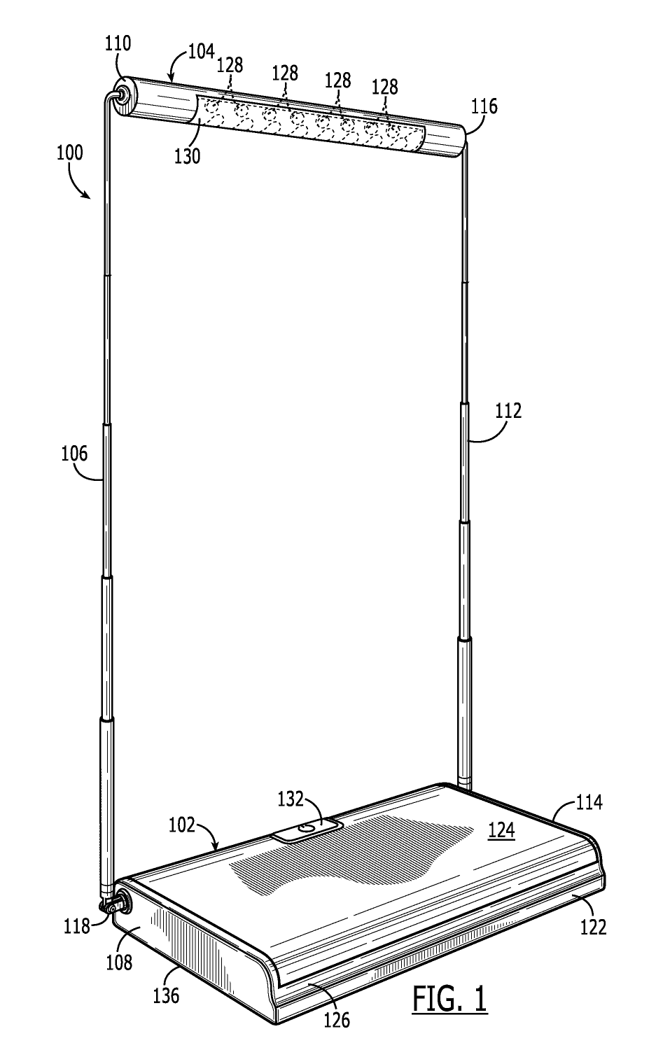

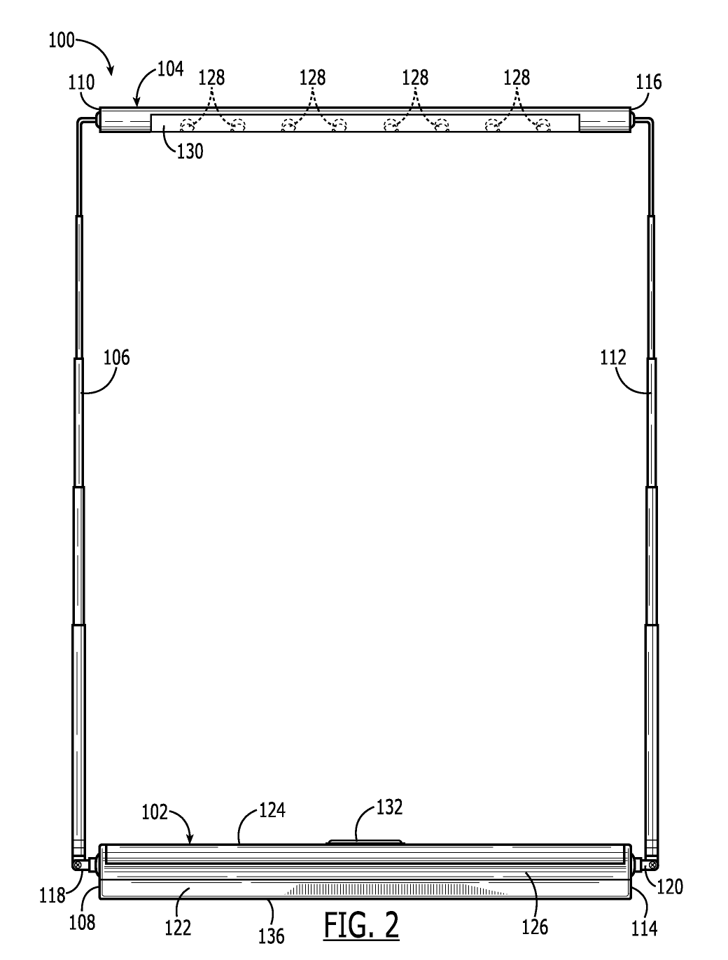

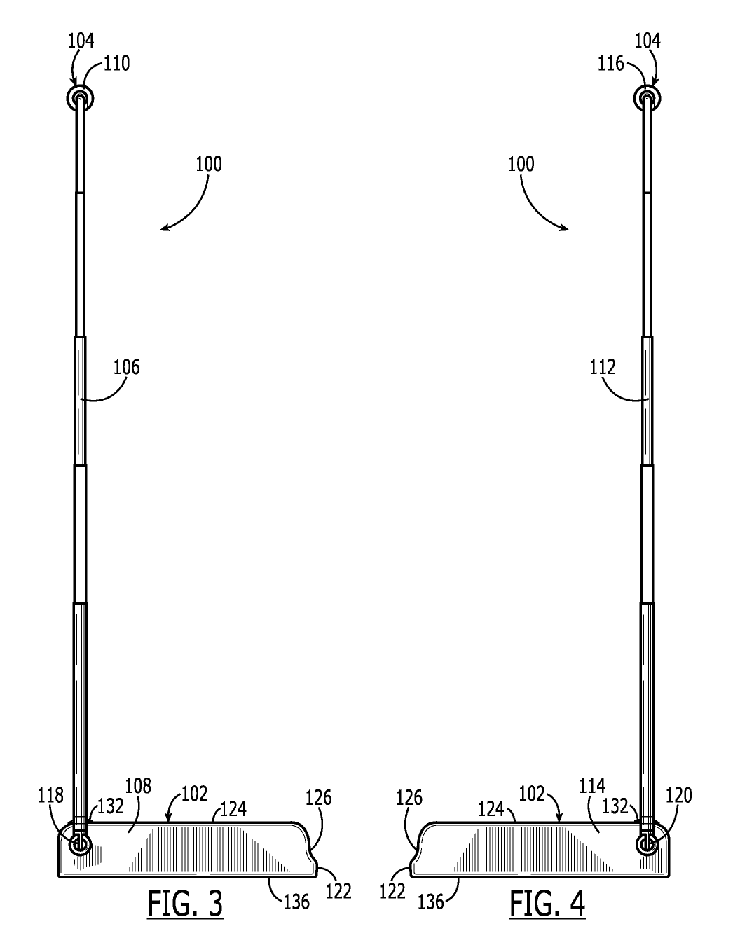

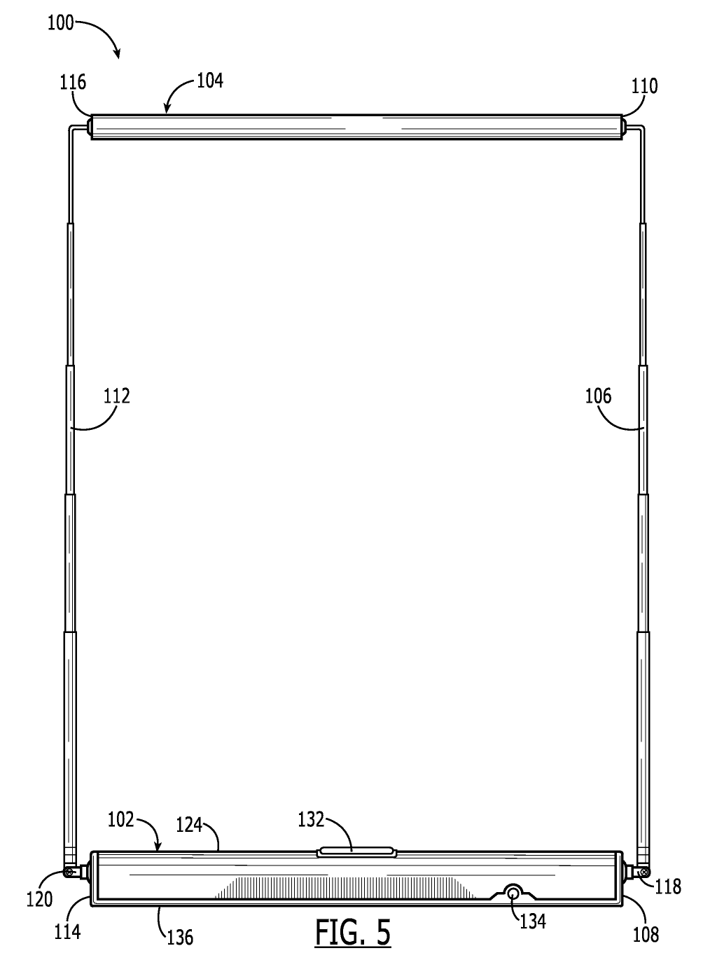

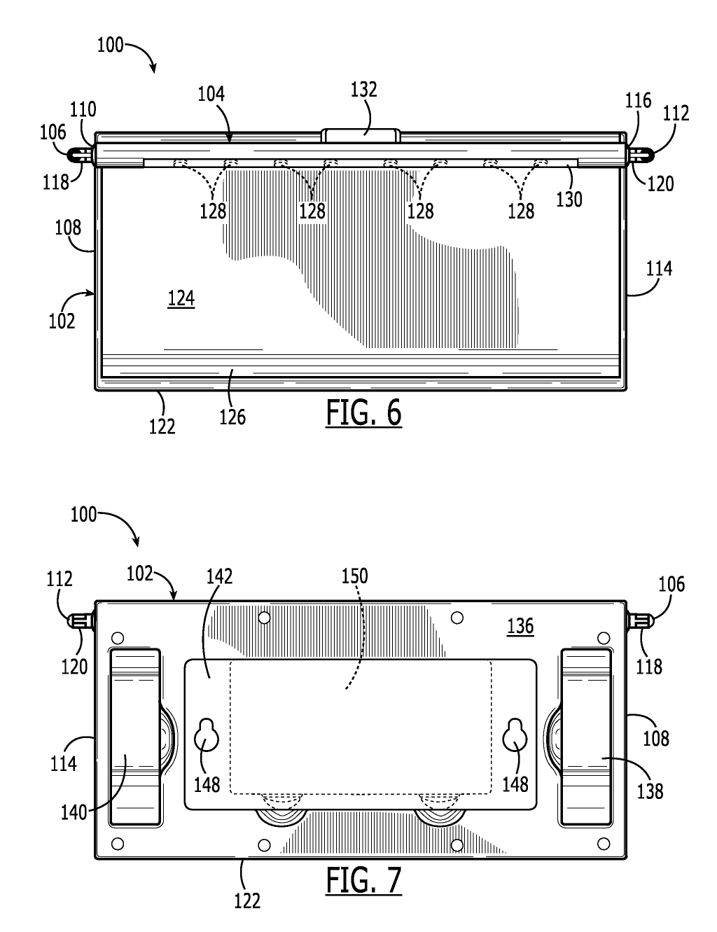

FIGS. 1-9 illustrate a first embodiment of the disclosed lighting device. The illustrated lighting device 100 includes a base 102, a light bar 104, a first extendable arm 106, and a second extendable arm 112. The first extendable arm 106 connects a first side surface 108 of the base 102 to a first side surface 110 of the light bar 104. Similarly, the second extendable arm 112 connects a second side surface 114 of the base 102 to a second side surface 116 of the light bar 104. First and second rotation hinges 118, 120 connect the first and second extendable arms 106, 112, respectively, to the base 102.

The first and second extendable arms 106, 112 are rotatable relative to the base 102 around a first rotation axis substantially parallel to a long axis of the light bar 104. This maneuverability, in combination with the variable length of the first and second extendible arms 106, 112, allows the light bar 104 to be repositioned around the first rotation axis at varying distances from the base 102. In addition, the light bar 104 is rotatable relative to the first and second extendable arms 106, 112 around a second rotation axis. The second rotation axis is substantially parallel to both the first rotation axis and the long axis of the light bar 104.

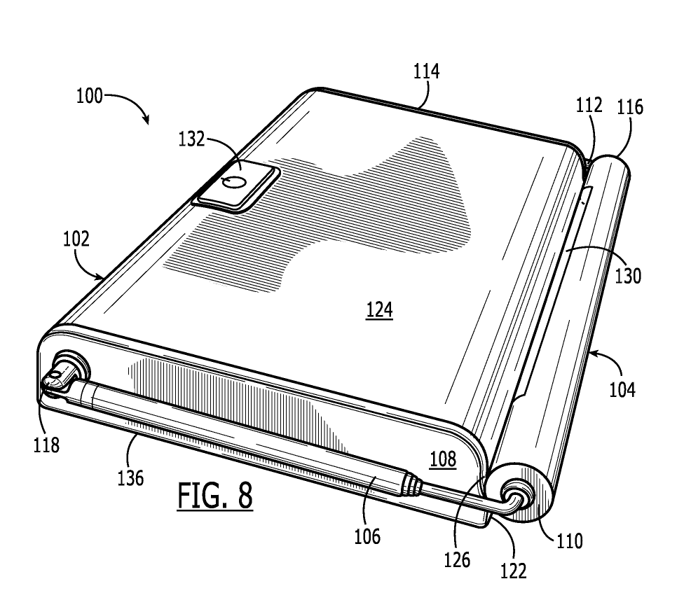

As shown in FIG. 8, the overall lighting device 100 can be converted into a compact configuration with the first and second extendible arms 106, 112 adjacent to the first and second side surfaces 108, 114, respectively, of the base 102, and the light bar 104 positioned adjacent to a front surface 122 of the base. In the compact configuration, the first and second extendable arms 106, 112 and the light bar 104 essentially wrap around the base 102 and are positioned substantially below a top surface 124 of the base. The front surface 122 of the base 102 includes a groove 126 shaped to receive the light bar 104 when the lighting device 100 is in the compact configuration.

The light bar 104 in the illustrated lighting device 100 includes lighting elements 128 positioned below a substantially transparent window 130. The lighting elements 128 are mounted on a reflective backing plate (not shown). Each of the lighting elements 128 is electrically connected via wires (not shown) to a battery compartment (not shown) within the base 102. The base 102 includes a power button 132 to control the flow of electricity between batteries within the battery compartment and the lighting elements 128. The base 102 also includes a DC port 134. A conventional power adapter can be plugged into the DC port 134 and into a wall outlet to provide an alternative power source for the lighting elements 128.

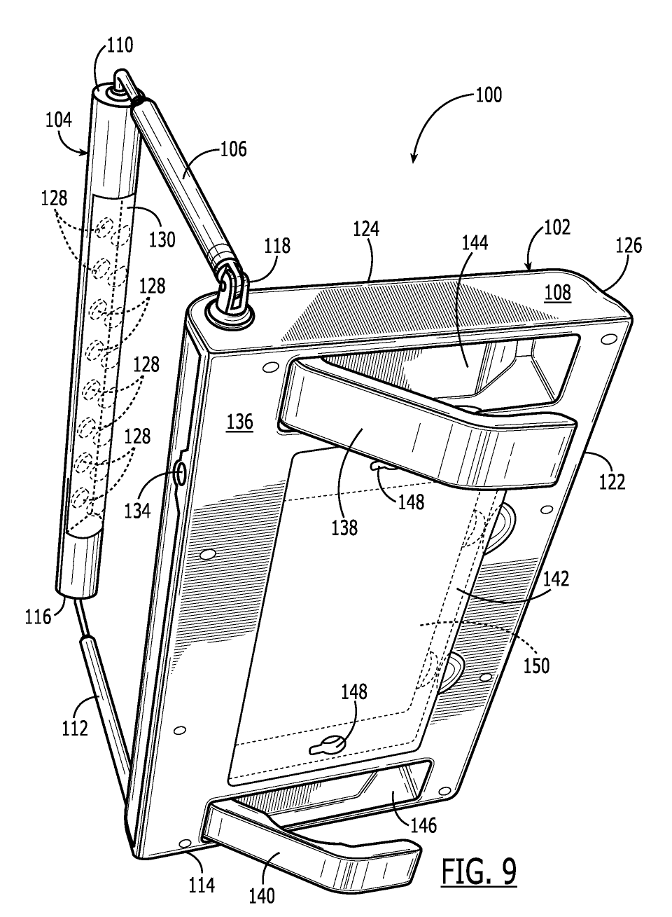

FIGS. 7 and 9 show a bottom surface 136 of the base 102. As shown in FIGS. 7 and 9, the bottom surface 136 of the base 102 includes first and second bottom mounting clips 138, 140 and a mounting plate 142. FIG. 9 shows the first and second bottom mounting clips 138, 140 extended away from the base 102. When not held in their extended positions, the first and second bottom mounting clips 138, 140 are spring-loaded to retract into first and second mounting clip recesses 144, 146, respectively. The first and second bottom mounting clips 138, 140 allow the lighting device 100 to be conveniently attached to another object (e.g., a book or a laptop computer). Alternatively, the lighting device 100 can be mounted to a wall using screws. Heads of the screws can be locked into screw holes 148 on the mounting plate 142. The mounting plate 142 is removable to allow the lighting device 100 to be separated from a wall without the need to remove the screws. A battery compartment cover 150 is located below the mounting plate 142. The battery compartment cover 150 is removable to allow access to the battery compartment within the base 102.

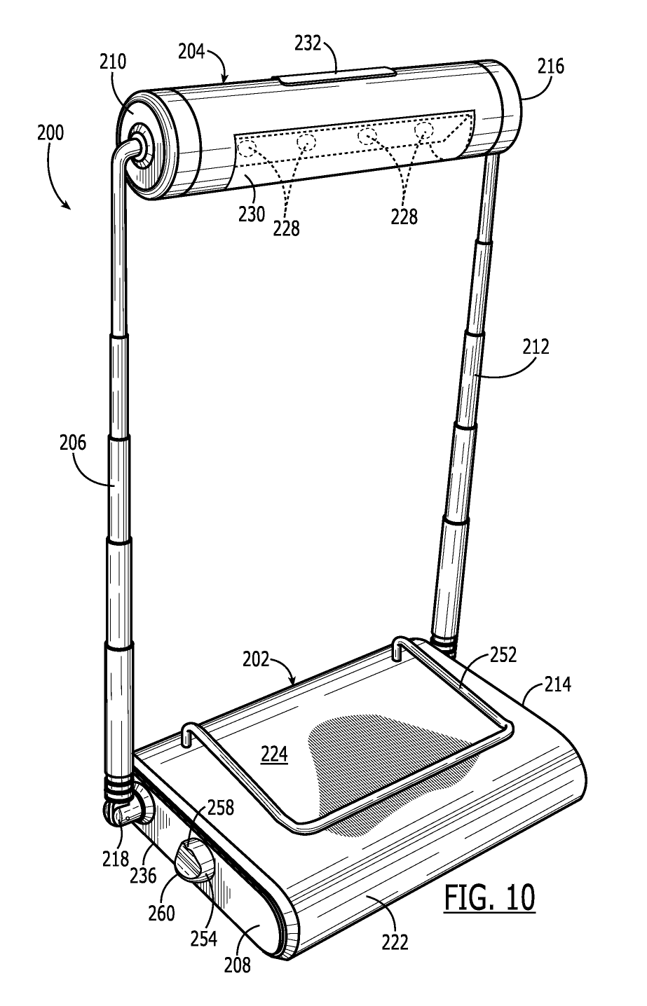

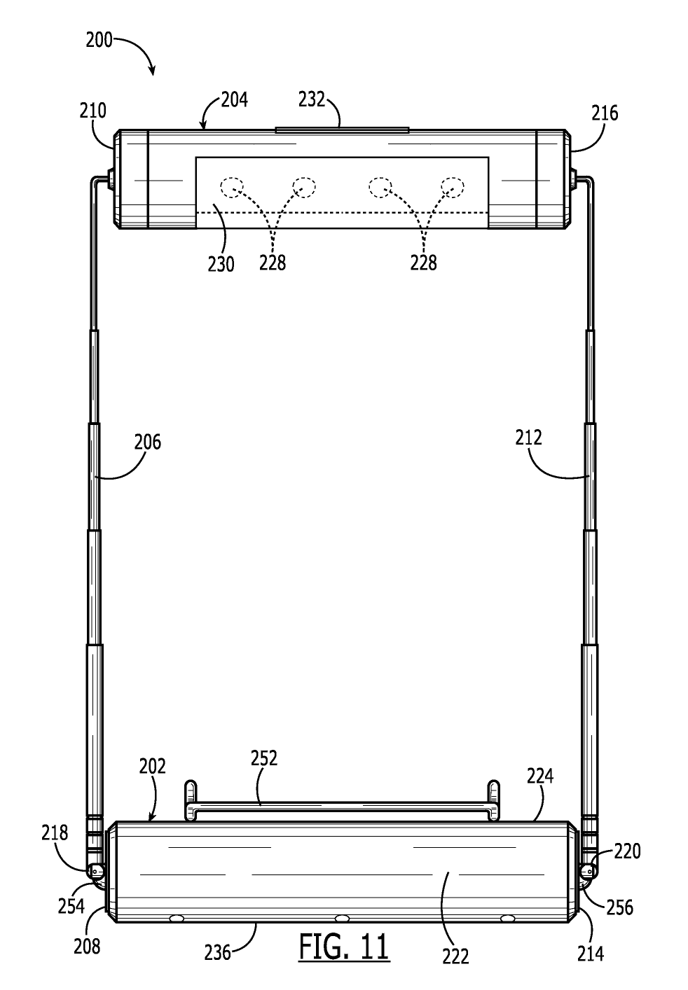

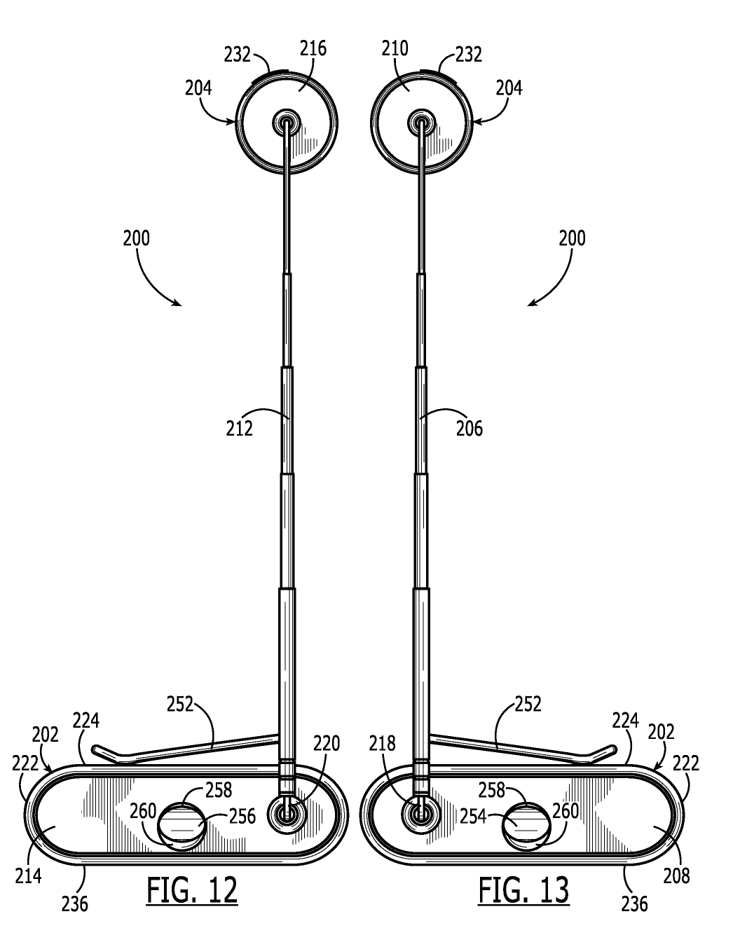

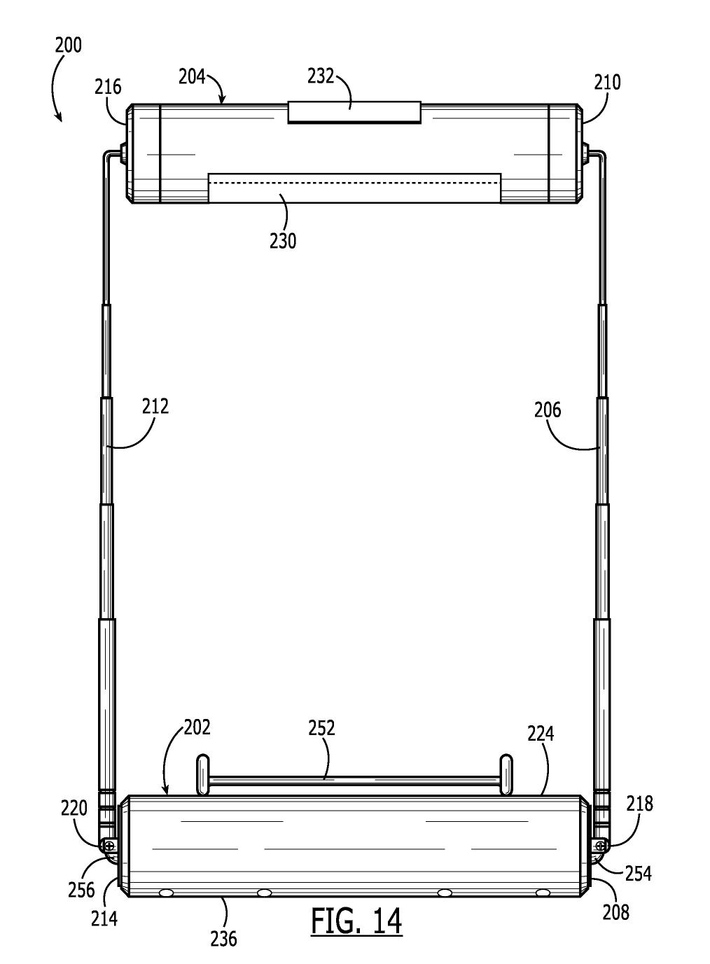

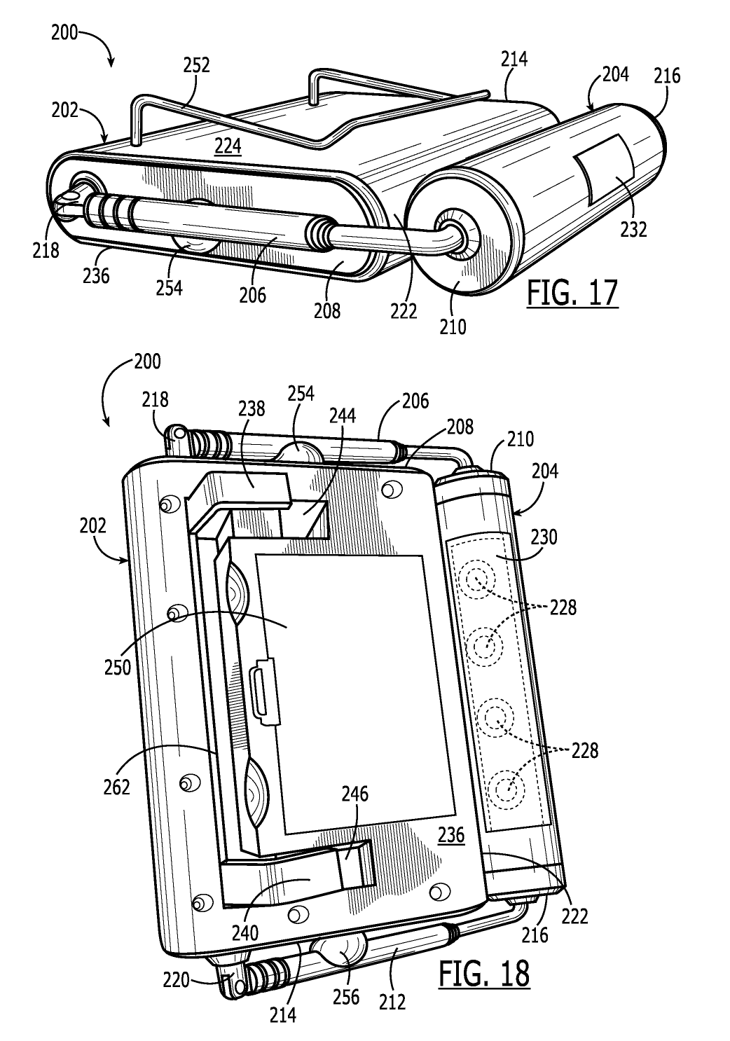

FIGS. 10-18 illustrate a second embodiment of the disclosed lighting device. The first digit of each reference number shown in FIGS. 10-18 is “2.” The final two digits of the reference numbers shown in FIGS. 10-18 are identical to the final two digits of the reference numbers shown in FIGS. 1-9 for similar or identical elements. Similar to the lighting device 100, the lighting device 200 includes a base 202, a light bar 204, a first extendible arm 206, and a second extendible arm 212. Also similar to the lighting device 100, the first and second extendible arms 206, 212 are rotatable relative to the base 202 around a first rotation axis and the light bar 104 is rotatable relative to the first and second extendible arms around a second rotation axis. The first and second rotation axes are substantially parallel, to a long axis of the light bar 204.

Unlike the lighting device 100 shown in FIGS. 1-9, the lighting device 200 includes a top mounting clip 252 as an alternative mechanism for attaching the lighting device to another object. The lighting device 200 also includes first and second extendable arm supports 254, 256 positioned on the first and second side surfaces 208, 214, respectively, of the base 202. The first and second extendable arm supports 254, 256 each include a top lip 258 and a bottom lip 260. As the first and second extendable arms 206, 212 are rotated toward the base 202, they each briefly press against the top lip 258 of the first and second extendable arm supports 254, 256, respectively, before snapping into place between the top lip and the bottom lip 260. In this way, the first and second extendable arm supports 254, 256 secure the first and second extendable arms 206, 212, respectively, in the compact configuration. The bottom lips 260 do not allow for further rotation of the first and second extendable arms 206, 212 beyond rotation into the compact configuration.

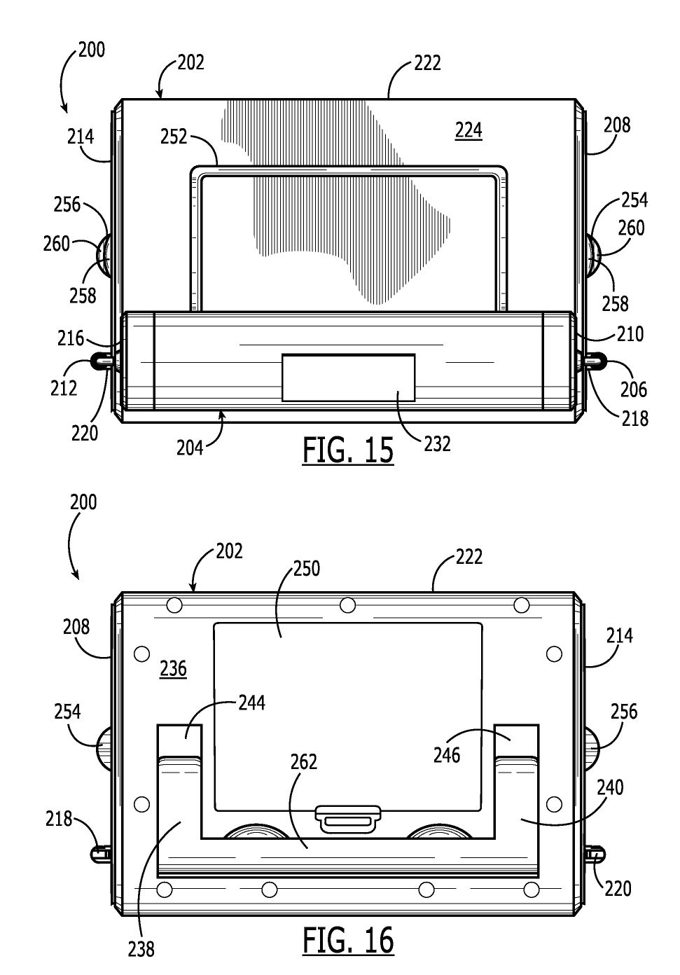

The lighting device 200 includes several additional differences relative to the lighting device 100. Unlike the lighting device 100, the front surface 222 of the lighting device 200 is rounded and does not include a groove. The power button 232 of the lighting device 200 is positioned on the light bar 204, rather than on the base 202. As shown in FIGS. 16 and 18, the bottom surface 236 of the base 202 of the lighting device 200 does not include a mounting plate. Instead, the battery compartment cover 250 is exposed. Also unlike the lighting device 100, the first and second bottom mounting clips 238, 240 of the lighting device 200 do not move independently. A mounting clip rail 262 connects the first and second mounting clips 238, 240, causing them to extend and retract in unison.

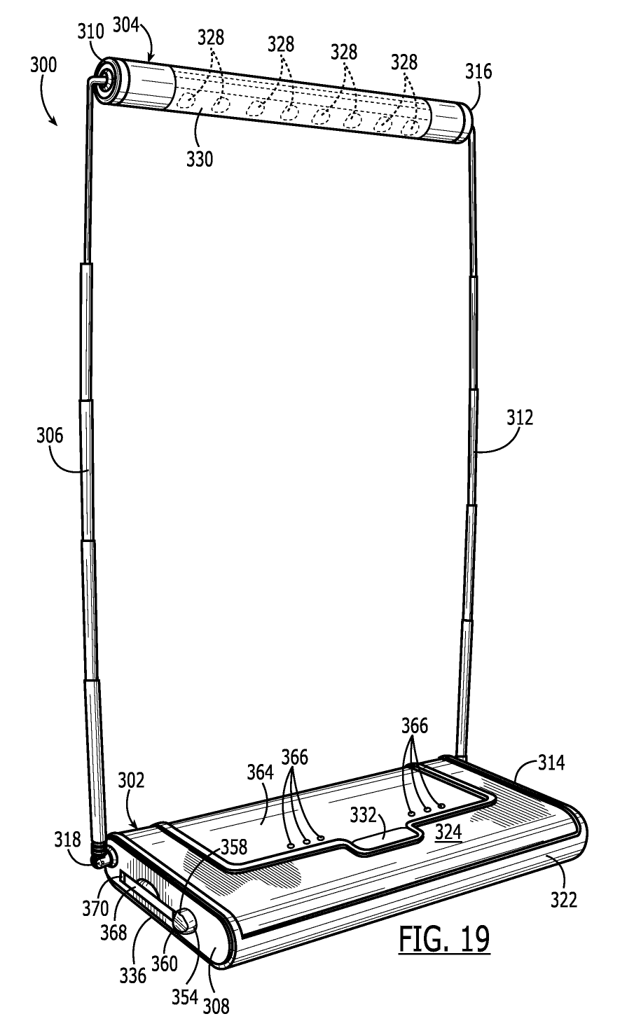

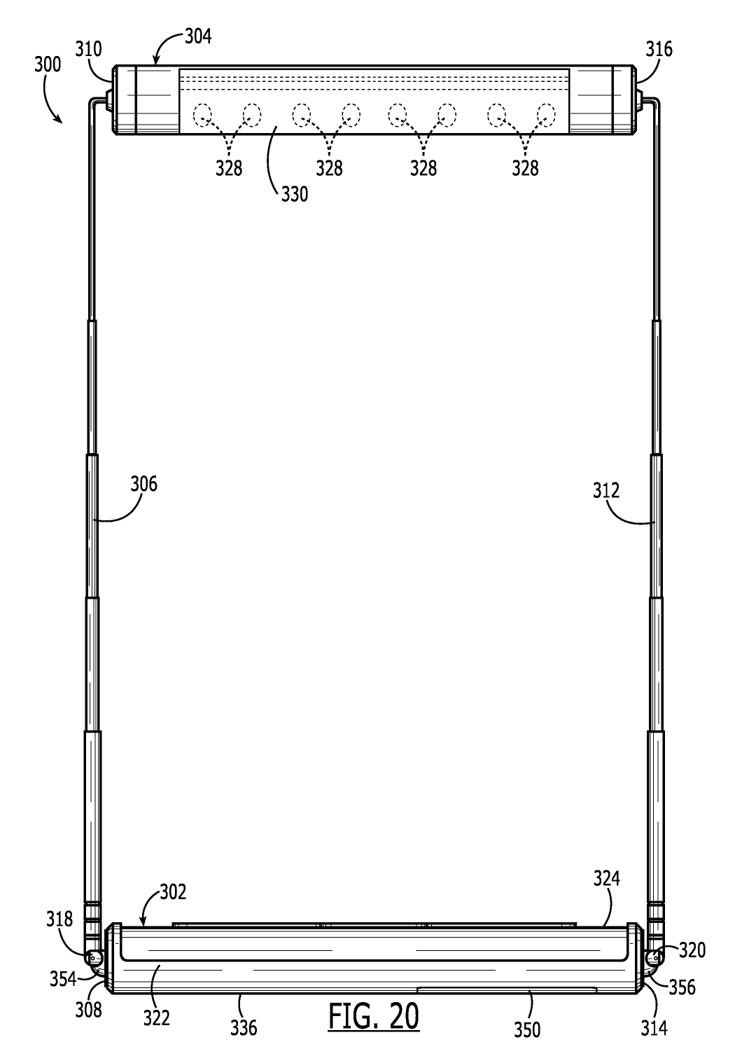

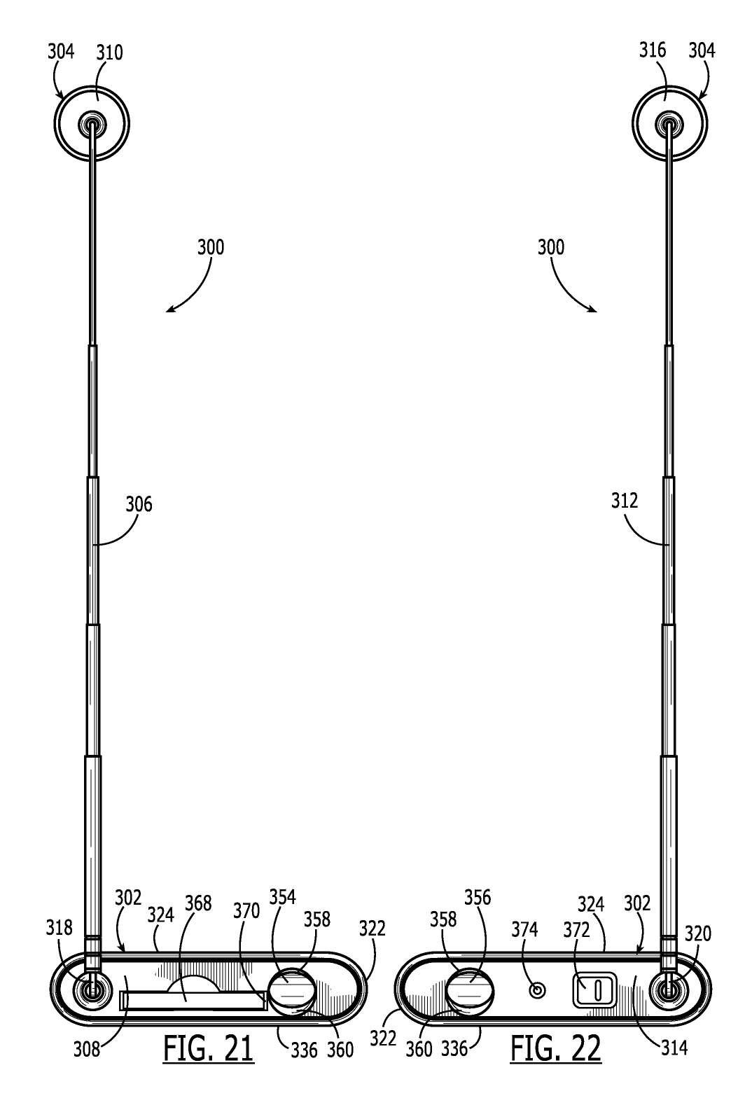

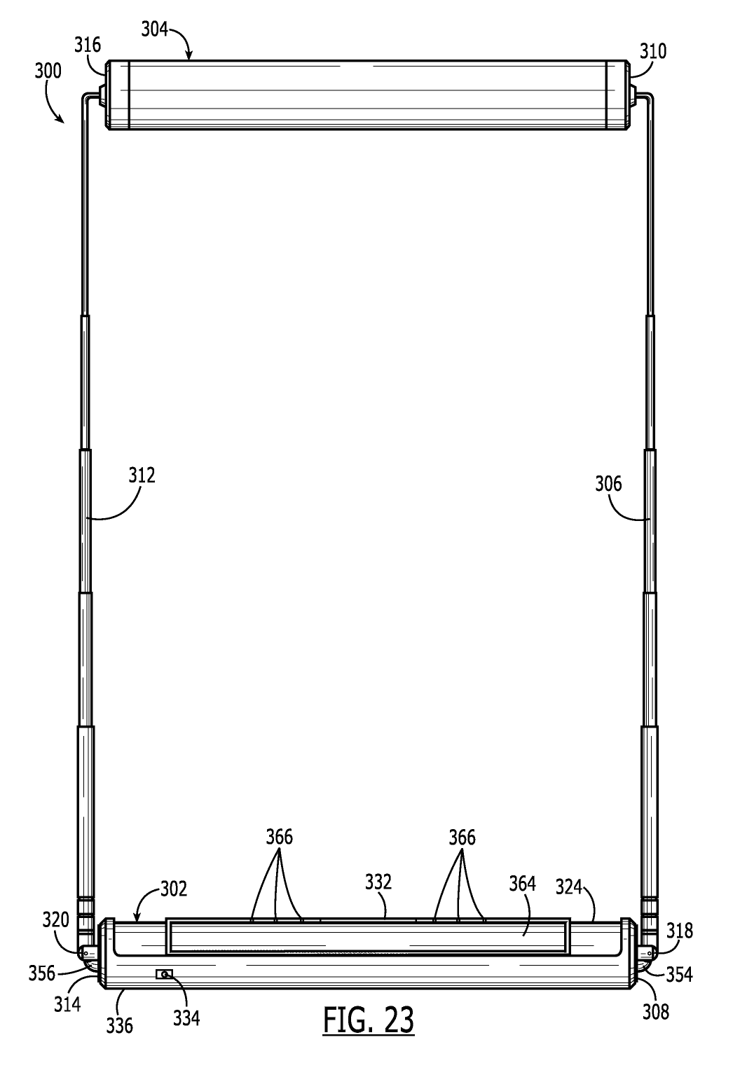

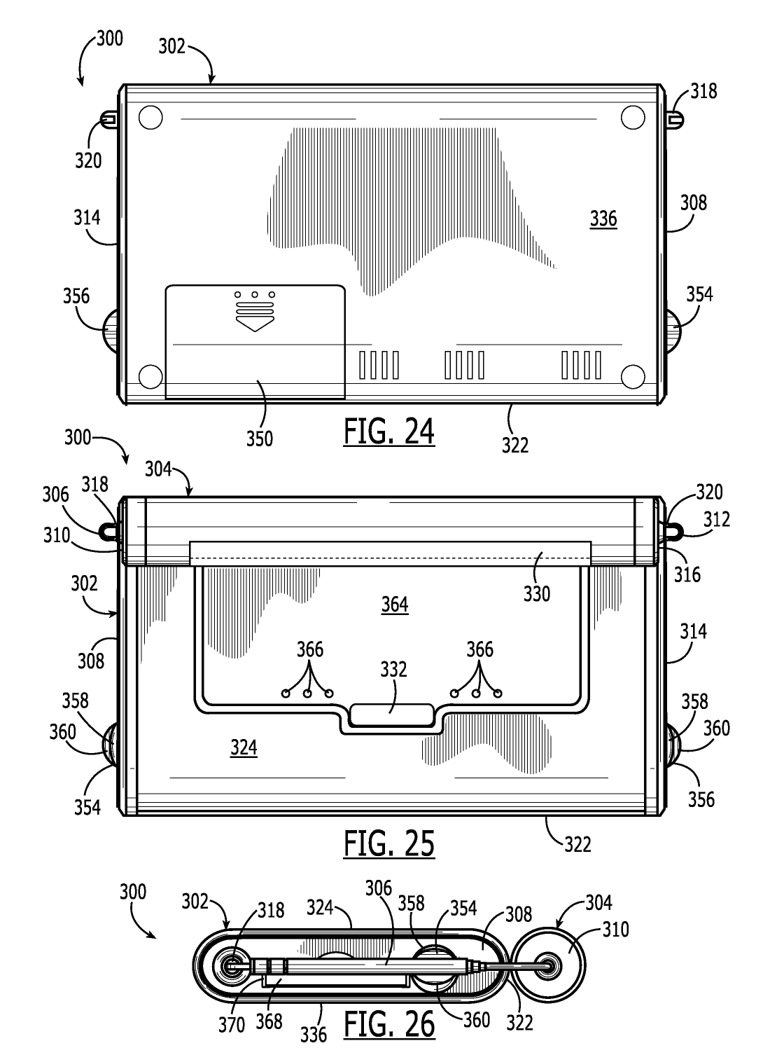

FIGS. 19-26 illustrate a third embodiment of the disclosed lighting device. The first digit of each reference number shown in FIGS. 19-26 is “3.” The final two digits of the reference numbers shown in FIGS. 19-26 are identical to the final two digits of the reference numbers shown in FIGS. 1-18 for similar or identical elements. Similar to the lighting devices 100, 200, the lighting device 300 includes a base 302, a light bar 304, a first extendible arm 306, and a second extendible arm 312. Also similar to the lighting devices 100, 200 the first and second extendible arms 306, 312 are rotatable relative to the base 302 around a first rotation, axis and the light bar 304 is rotatable relative to the first and second extendible arms around a second rotation axis. The first and second rotation axes are substantially parallel to a long axis of the light bar 304.

Similar to the lighting device 100 shown in FIGS. 1-9, the power button 332 is located on the base 302 rather than on the light bar 304. Similar to the lighting device 20 shown in FIGS. 10-18, the lighting device 300 includes first and second extendable arm supports 354, 356 and an exposed battery compartment cover 350. The lighting device 300 also includes features not found in either the lighting device 100 or the lighting device 200. For example, the lighting device 300 includes a storage compartment (not shown) in the base 302 below a storage compartment cover 364. The storage compartment cover 364 includes grip tabs 366 to assist with opening and closing. The lighting device 300 also includes a removable magnifier 368 stowed within a magnifier slot 370 extending through the first side surface 308 of the base 302. As with the lighting device 100, the lighting device 300 includes a DC port 334. The lighting device 300, however, also includes a manual power supply switch 372 and an indicator light 374. The manual power supply switch 372 allows a user to manually toggle the power source for the lighting elements 328 between batteries and an external power source connected via the DC port 334. The indicator light 374 illuminates when power is being received via the DC port 334.

In the lighting devices 100, 200, 300 illustrated in FIGS. 1-26, the bases 102, 202, 302 are shaped substantially as rectangular solids. The top surfaces 124, 224, 324 of the bases 102, 202, 302 and cross-sectional profiles of the bases in planes substantially perpendicular to the long axes of the corresponding light bars 104, 204, 304 are substantially rectangular. Other embodiments can have bases with different shapes. For example, some embodiments include a base with a top surface that substantially resembles an alternative quadrilateral (e.g., a trapezoid), another polygon (e.g., a triangle, a pentagon, a hexagon, a heptagon, or an octagon), a circle, an oval, or a circular segment (e.g., a semicircle). Similarly, some embodiments include a base with a cross-sectional profile in a plane substantially perpendicular to the long axis of the corresponding light bar that substantially resembles an alternative quadrilateral (e.g., a trapezoid), another polygon (e.g., a triangle, a pentagon, a hexagon, a heptagon, or an octagon), a circle, an oval, or a circular segment (e.g., a semicircle). In embodiments of the disclosed lighting device, the base typically has a cross-sectional profile in a plane substantially perpendicular to the long axis of the corresponding light bar with a height-to-width ratio from about 1:2 to about 1:40, such as from about 1:3 to about 1:20 or from about 1:4 to about 1:10. Greater width than height in the base gives these embodiments a compact shape, a low profile, and good stability. The bases in embodiments of the disclosed lighting device can be made of a variety of materials (e.g., plastic, fiberglass, graphite, and metal).

The light bars 104, 204, 304 in the illustrated lighting devices 100, 200, 300 are cylindrical and elongated. Other embodiments can have light bars with different shapes. For example, some embodiments include a light bar with a cross sectional profile in a plane perpendicular to its long axis that substantially resembles a polygon (e.g., a triangle, a quadrilateral, a pentagon, a hexagon, a heptagon, or an octagon), an oval, or a circular segment (e.g., a semicircle). The light bars in embodiments of the disclosed lighting device can be made of a variety of materials (e.g., plastic, fiberglass, graphite, and metal). In the illustrated lighting devices 100, 200, 300, the light bars 104, 204, 304 touch or nearly touch the front surfaces 122, 222, 322 of the corresponding bases 102, 202, 302 when the lighting devices are in the compact configuration. In other embodiments, the light bar can be positioned less than about 10 cm from the front surface of the base, such as less than about 5 cm or less than about 2 cm when the lighting device is in the compact configuration.

The windows in the light bars can be made of plastic, glass, or another substantially optically transmissive material. The length of the windows can be, for example, between about 20% and about 100% of the length of the overall light bar, such as between about 50% and about 100% or between about 60% and about 90%. The majority of the inside surface of the windows can be coated to give them a slightly frosted appearance. In the illustrated lighting devices 100, 200, 300, the windows 130, 230, 330 include uncoated regions corresponding to each of the lighting elements 128, 228, 328.

The illustrated lighting devices 100, 300 include eight lighting elements 128, 328 each. The illustrated lighting device 200 includes four lighting elements 228. Other embodiments can include a different number of lighting elements, such as one, two, three, five, six, seven, nine, ten, or a greater number of lighting elements. In each of the lighting devices 100, 200, 300, the lighting elements 128, 228, 328 are arranged in a single row that is substantially parallel to the long axis of the surrounding light bar 104, 204, 304. In other embodiments the lighting elements can have different arrangements. For example, the lighting elements can be arranged in multiple rows that are substantially parallel to the long axis of the light bar or in one or more rows that are substantially perpendicular to the long axis of the light bar. The lighting elements also can be arranged, for example, in clusters or in a staggered pattern.

In the illustrated lighting devices 100, 200, 300, the lighting elements 128, 228, 328 are white light emitting diodes. Instead of light emitting diodes, other embodiments of the disclosed lighting device can include incandescent, fluorescent, halogen, xenon, neon, or some other commercially available lighting type. Light emitting diodes, however, are particularly well suited for use in the disclosed lighting device due to their compact size, low power demand, low heat output, long life, and high durability. Instead of white light emitting diodes, other embodiments can include light emitting diodes of another color, such as red, orange, yellow, green, or blue.

The first and second extendable arms 106, 112, 206, 212, 306, 312 in the illustrated lighting devices 100, 200, 300 each include multiple interlocking segments that allow the first and second extendable arms to lengthen and shorten telescopically. The interlocking segments nest within one another as the first and second extendable arms 106, 112, 206, 212, 306, 312 are shortened. Stops (not shown) within the first and second extendable arms 106, 112, 206, 212, 306, 312 prevent the interlocking segments from fully separating during extension. Other embodiments of the disclosed lighting device can include extendable arms that operate by an alternative mechanism, such as a conventional scissoring or serpentine extension mechanism. In the illustrated lighting devices 100, 200, 300, the first and second extendable arms 106, 112, 206, 212, 306, 312 are made of metal, but other embodiments can include first and second extendable arms made of a different material (e.g., plastic, fiberglass, or graphite).

The battery compartments of the lighting devices 100, 300 are configured to hold six size AA batteries with the long axis of each battery substantially parallel to the long axis of she light bars 104, 304. The battery compartment of the lighting device 200 is configured to hold three size AAA batteries with the long axis of each battery substantially parallel to the long axis of the light bar 204. The battery compartments in all three illustrated lighting devices 100, 200, 300 are configured so that installed batteries are electrically connected in series with soldered connections (not shown) at the beginning and end of the series. Wires (not shown) extend between the soldered connections of the battery compartments and contacts on backing plates (not shown) of the lighting elements 128, 228, 328. The backing plates are connected to circuit boards (not shown) that control the flow of electricity to the lighting elements 128, 228, 328 in response to signals from the power buttons 130, 230, 330.

The illustrated lighting devices 200, 300 include first and second extendable arm supports 254, 256, 354, 356 that restrict rotation of the light bars 204, 304 and the first and second extendable arms 206, 212, 306, 312 around the first rotation axis. This helps to prevent wiring within the lighting devices 200, 300 from becoming tangled or breaking from excess tension. Other embodiments can include different mechanisms or no mechanisms for protecting the wiring in this manner.

In addition to or instead of using battery power, the illustrated lighting devices 100, 300 can use power drawn from an external power source (e.g., a standard electrical receptacle or a USB receptacle) via the DC ports 134, 334. When the lighting device 100 begins receiving power from an external power source, power draw from batteries within the battery compartment automatically ceases to preserve battery life. In contrast, when the lighting device 300 is connected to an external power source, the power draw for the lighting elements 328 can be manually toggled between the batteries and the external power source via the manual power supply switch 372.

Other embodiments can include different electrical configurations. Embodiments powered exclusively or optionally by batteries can include any number, type, and arrangement of batteries, such four AA batteries in series or one nine-volt battery directly connected to the circuit. The batteries can be housed in one, two, three, four, or a greater number of battery compartments. Other embodiments can be hard wired to a permanent power source, such as a wall circuit. Embodiments that can be plugged into a standard electrical receptacle can include an electrical cord permanently or removably attached to the lighting device. Hard-wired and plug-in embodiments can include an adaptor to modify the voltage of a conventional wall circuit. Such an adaptor can be positioned, for example, within the base of the lighting device or along a cord attached to the lighting device.

In the illustrated lighting devices 100, 200, 300, the power buttons 130, 230, 330 turn the lighting elements 128, 228, 328 either on or off. Other embodiments can have a power button configured to toggle the lighting elements between different levels of light intensity. For example, a single press of the power button can turn on the lighting elements, a second press of the power button can increase the light intensity, and a third press of the power button can turn off the lighting elements. Alternatively, the power button can be configured to toggle between the activation of different numbers of lighting elements from among a plurality of lighting elements. For example, a single press of the power button can turn on every-other lighting element, a second press of the power button can turn on all of the lighting elements, and a third press of the power button can turn off all of the lighting elements. The functionality of toggling the light intensity or the number of illuminated lighting elements can be incorporated by including a commercially available dimmer or toggle switch on a circuit board electrically connected to the lighting elements. Instead of a power button, other embodiments can include another type of switch, such as a toggle switch, a rocker switch, or a dial.

Embodiments of the disclosed lighting device can be installed and used in a variety of orientations. For example, the illustrated lighting devices 100, 200, 300 can be installed and used with the bases 102, 202, 302 oriented substantially horizontally and the top surfaces 124, 224, 324 of the bases facing upward, such as by resting the lighting devices on a substantially flat surface (e.g., the surface of a desk). Alternatively, the lighting devices 100, 200, 300 can be installed and used with the bases 102, 202, 302 oriented substantially horizontally and the top surfaces 124, 224, 324 of the bases facing downward, such as by mounting the lighting devices to the underside of a substantially flat surface (e.g., the underside of a kitchen cabinet). The lighting devices 100, 200, 300 also can be installed and used with the bases 102, 202, 302 oriented substantially vertically. For example, the lighting devices 100, 200, 300 can be mounted to a substantially vertical wall with the top surfaces 124, 224, 324 of the bases facing away from the wall.

As discussed above, the lighting devices 100, 200 include first and second bottom mounting clips 138, 140, 238, 240. The lighting device 100 includes a mounting plate 142 and screw holes 148. The lighting device 200 includes a top mounting clip 252. In addition to or instead of these elements, embodiments of the disclosed lighting device can include other mounting mechanisms. For example, some disclosed embodiments include fastening material (e.g., adhesive material, magnetic material, or hook-and-loop material) on the bottom surface of the base.

Embodiments of the disclosed lighting device can include a variety of features in addition to or in place of those described above and shown in FIGS. 1-26. For example, some embodiments include a sensor that activates and deactivates the lighting elements. In some embodiments, this sensor is a light sensor, such as a commercially available light sensor that activates the lighting elements when light from another source is detected. This can be useful for applications in which the disclosed lighting device is not the primary lighting device for an area. Once the primary lighting device for an area (e.g., an overhead light) is activated, embodiments of the disclosed lighting device can be configured to activate automatically. In this way, secondary lighting, such as accent lighting, can be activated without the need for manual intervention. By the same principle, the lighting device can be activated by a motion sensor, such as a commercially available motion sensor. Embodiments including a sensor also can include a manual override switch to deactivate the sensor when automatic operation is not desirable. The manual override switch can be, for example, a commercially available switch that switches the flow of electrical current between a circuit including the sensor and a circuit not including the sensor.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A lighting device, comprising:
a base;
an elongated light bar including two or more light emitting diodes, and having a long axis between a first end and a second end;
a first extendable arm connecting the elongated light bar to the base, and having a long axis between a first end and a second end; and
a second extendable arm connecting the elongated light bar to the base, and having a long axis between a first end and a second end, wherein the long axis of the elongated light bar is substantially perpendicular to the long axes of the first and second extendable arms, the first and second extendable arms are rotatable relative to the base around a first rotation axis, the elongated light bar is rotatable relative to the first and second extendable arms around a second rotation axis, the first and second rotation axes are substantially parallel to the long axis of the elongated light bar, and the lighting device is collapsible into a compact configuration with the long axes of the first and second extendable arms substantially parallel to a support or mounting surface.

2. The lighting device according to claim 1, wherein a cross-sectional profile of the base in a plane substantially perpendicular to the long axis of the elongated light bar has a height-to-width ratio from about 1:3 to about 1:20.

3. The lighting device according to claim 1, wherein the base includes a battery compartment.

4. The lighting device according to claim 1, wherein the base includes a storage compartment.

5. The lighting device according to claim 1, wherein the first and second extendable arms are telescoping.

6. The lighting device according to claim 1, wherein the light emitting diodes are positioned behind a substantially transparent, window, and the length of the substantially transparent window is between about b 50% and about 100% of the length of the elongated light bar.

7. The lighting device according to claim 1, wherein the base is shaped substantially as a rectangular solid.

8. The lighting device according to claim 1, wherein the range over which the first and second extendable arms can be rotated around the first rotation axis is restricted.

9. The lighting device according to claim 1, further comprising a first extendable arm support connected to a first side surface of the base and a second extendable arm support connected to a second side surface of the base, wherein the first and second extendable arm supports are shaped to releaseably secure the first and second extendable arms, respectively, to the base when the lighting device is in the compact configuration.

10. The lighting device according to claim 9, wherein the first and second extendable arm supports restrict rotation of the first and second extendable arms, respectively, around the first rotation axis.

11. The lighting device according to claim 1, wherein the base includes a mounting clip.

12. The lighting device according to claim 11, wherein the mounting clip is spring-loaded to retract into a mounting clip recess within the base.

13. A lighting device, comprising:
a base having a first side surface and a second side surface;
an elongated light bar including two or more light emitting diodes, and having a long axis between a first end and a second end;
a first extendable arm having a long axis between a first end and a second end, the first end of the first extendable arm being connected to the first side surface of the base, and the second end of the first extendable arm being connected to the first end of the elongated light bar; and
a second extendable arm having a long axis between a first end and a second end, the first end of the second extendable arm being connected to the second side surface of the base, and the second end of the second extendable arm being connected to the second end of the elongated light bar, wherein the long axis of the elongated light bar is substantially perpendicular to the long axes of the first and second extendable arms, the long axis of the elongated light bar is substantially perpendicular to the first and second side surfaces of the base, the long axes of the first and second extendable arms are substantially parallel to the first and second side surfaces of the base, the first and second extendable arms are rotatable relative to the base around a first rotation axis, the elongated light bar is rotatable relative to the first and second extendable arms around a second rotation axis, and the first and second rotation axes are substantially parallel to the long axis of the elongated light bar.

14. The lighting device according to claim 13, wherein the base includes a battery compartment.

15. The lighting device according to claim 13, being collapsible into a compact configuration with the first and second extendable arms positioned adjacent to the first and second side surfaces of the base, respectively.

16. The lighting device according to claim 15, further comprising a first extendable arm support connected to the first side surface of the base and a second extendable arm support connected to the second side surface of the base, wherein the first and second extendable arm supports are shaped to releaseably secure the first and second extendable arms, respectively, to the base when the lighting device is in the compact configuration, and the first and second extendable arm supports restrict rotation of the first and second extendable arms, respectively, around the first rotation axis.

17. The lighting device according to claim 13, wherein the base has a top surface substantially perpendicular to the first and second side surfaces of the base and a front surface substantially perpendicular to the top and first and second side surfaces of the base, and the lighting device is collapsible into a compact configuration with the long axes of the first and second extendable arms substantially perpendicular to the front surface of the base and the elongated light bar positioned adjacent to the front surface of the base.

18. The lighting device according to claim 17, wherein the elongated light bar, the first extendable arm, and the second extendable arm do not substantially project beyond the top surface of the base when the lighting device is in the compact configuration.

19. A lighting device, comprising;
a base having a first side surface and a second side surface;
an elongated light bar including two or more light emitting means for producing light, the elongated light bar having a long axis between a first end and a second end, the long axis of the elongated light bar being positioned substantially perpendicular to the first and second side surfaces of the base;
extension means for extending the elongated light bar away from the base;
first hinge means for allowing the position of the elongated light bar to be rotated relative to the base around a first rotation axis substantially parallel to the long axis of the elongated light bar; and
second hinge means for allowing the elongated light bar to be rotated relative to the first hinge means around a second rotation axis substantially parallel to the long axis of the elongated light bar.

20. The lighting device according to claim 19, further comprising mounting means for releasably attaching the base to another object.
